(19) United States
(12) Patent Application Publication
(10) Pub. No.: US 2025/0342052 A1
(43) Pub. Date: Nov. 6, 2025

(54) APPLICATION GATEWAYS IN AN ON-DEMAND NETWORK CODE EXECUTION SYSTEM

(71) Applicant: Amazon Technologies, Inc., Seattle, WA (US)

(72) Inventors: Lodaya Varun Mukesh, Mill Creek, WA (US); Sridhar Srinivasan, Bothell, WA (US); Hamza Arain, Bellevue, WA (US)

(21) Appl. No.: 19/212,519

(22) Filed: May 19, 2025

Related U.S. Application Data
(63) Continuation of application No. 16/362,515, filed on Mar. 22, 2019, now Pat. No. 12,327,133.

(51) Int. Cl. G06F 9/48; G06F 8/41; G06F 9/50

(52) U.S. Cl. CPC G06F 9/485; G06F 8/41; G06F 9/4881; G06F 9/505; G06F 9/5083; G06F 9/5005; G06F 9/5072

(57) ABSTRACT

Systems and methods are described for providing an application-level gateway to an on-demand network code execution system. An on-demand network code execution system may allow users to submit code to be executed in a serverless environment, and may provide an interface for executing the user-submitted code on demand. The interface may require that users authenticate, provide input in a particular format, or meet other criteria when sending a request to execute the code. An application-level gateway may thus provide an interface that implements these functions, thereby allowing computing devices to interact with the code as though it were running on a server (e.g., by using HTTP). The application-level gateway may also use on-demand code execution to provide load balancing for servers that are running the user-submitted code, and seamlessly provide access to code that runs on both server-based and serverless environments.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application is a continuation of U.S. patent application Ser. No. 16/362,515, entitled “APPLICATION GATEWAYS IN AN ON-DEMAND NETWORK CODE EXECUTION SYSTEM” and filed on Mar. 22, 2019, the disclosure of which is incorporated herein by reference in its entirety.

### BACKGROUND

Generally described, computing devices can utilize communication networks to exchange data. Companies and organizations operate computer networks that interconnect a number of computing devices to support operations or provide services to third parties. The computing systems can be located in a single geographic location or located in multiple, distinct geographic locations (e.g., interconnected via private or public communication networks). Specifically, hosted computing environments or data processing centers, generally referred to herein as “data centers,” may include a number of interconnected computing systems to provide computing resources to users of the data center. The data centers may be private data centers operated on behalf of an organization, or public data centers operated on behalf, or for the benefit of, the general public.

To facilitate increased utilization of data center resources, virtualization technologies allow a single physical computing device to host one or more instances of virtual machines that appear and operate as independent computing devices to users of a data center. With virtualization, the single physical computing device can create, maintain, delete, or otherwise manage virtual machines in a dynamic manner. In turn, users can request computing resources from a data center, such as single computing devices or a configuration of networked computing devices, and be provided with varying numbers of virtual machine resources.

In some scenarios, a user can request that a data center provide computing resources to execute a particular task. The task may correspond to a set of computer-executable instructions, which the data center may then execute on behalf of the user. The data center may thus further facilitate increased utilization of data center resources.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram depicting an illustrative environment in which an on-demand code execution gateway facilitates access to an on-demand code execution system in accordance with aspects of the present disclosure.

FIG. 2 depicts a general architecture of a computing device providing the on-demand code execution gateway depicted in FIG. 1.

FIGS. 3A and 3B are flow diagrams depicting illustrative interactions for using an on-demand code execution gateway to allow an on-demand code execution system to fulfill requests for network resources in accordance with aspects of the present disclosure.

FIG. 4 is a flow chart depicting an illustrative routine for facilitating interactions between an on-demand code execution system and a client computing device that is not configured to access the on-demand code execution system, in accordance with aspects of the present disclosure.

FIG. 5 is a flow chart depicting an illustrative routine for using an on-demand code execution gateway to manage server resources in a hosted computing environment that includes an on-demand code execution system.

### DETAILED DESCRIPTION

Generally described, aspects of the present disclosure relate to an on-demand code execution system. The on-demand code execution system enables rapid execution of code, which may be supplied by users of the on-demand code execution system. More specifically, embodiments of the present disclosure relate to an on-demand code-execution gateway, which facilitates access to the on-demand code execution system. As described in detail herein, the on-demand code execution system may provide a network-accessible service enabling users to submit or designate computer-executable code to be executed by isolated execution environments on the on-demand code execution system. Each set of code on the on-demand code execution system may define a “task,” and implement specific functionality corresponding to that task when executed on an execution environment, such as a virtual machine instance, of the on-demand code execution system. Individual implementations of the task on the on-demand code execution system may be referred to as an “execution” of the task (or a “task execution”). The on-demand code execution system can further enable users to trigger execution of a task based on a variety of potential events, such as detecting new data at a network-based storage system, transmission of an application programming interface (“API”) call to the on-demand code execution system, or transmission of a specially formatted hypertext transport protocol (“HTTP”) packet to the on-demand code execution system. Thus, users may utilize the on-demand code execution system to execute any specified executable code “on-demand,” without requiring configuration or maintenance of the underlying hardware or infrastructure on which the code is executed. Further, the on-demand code execution system may be configured to execute tasks in a rapid manner (e.g., in under 100 milliseconds [ms]), thus enabling execution of tasks in “real-time” (e.g., with little or no perceptible delay to an end user).

The on-demand code execution system may thus allow users to execute code in a “serverless” environment (e.g., one in which the underlying server is not under user control), but may require that user requests to execute code in the environment meet criteria that would not otherwise be applicable. For example, the on-demand code execution system may require that code execution requests be authenticated with a cryptographic signature, submitted in a particular format, submitted via an API, or meet other requirements. In some aspects, satisfying these criteria may require computing resources that a computing device does not have. For example, an “Internet of Things” (“IoT”) device may have limited processing power or memory, and thus may not have sufficient computing resources to generate a cryptographic signature or convert a request to a particular format. Additionally, in some aspects, the on-demand code execution system may provide output in a particular format, and a computing device with limited computing resources may not understand the format or have the resources to translate it.

An on-demand code execution gateway may thus provide an interface that allows computing devices to interact with an on-demand code execution system regardless of whether the computing devices are capable of providing input in the format expected by the system or parsing output in the format provided by the system. The on-demand code execution gateway may thus allow computing devices to interact with code executing in the serverless on-demand environment as though the code were executing on a conventional server, and may thereby allow the on-demand code execution system to be utilized more efficiently. In some embodiments, computing devices may request a network resource or service, such as access to a web page, web-based application, database, file, image, media content, data stream, or the like. The on-demand code execution gateway may determine whether to fulfill the request by sending it to a server specifically configured to handle the request, or by generating and sending a request for on-demand code execution and then processing the resulting output.

The term “serverless environment,” as used herein, is intended to refer to an environment in which responsibility for managing generation, configuration, and state of an underlying execution environment is abstracted away from a user, such that the user need not, for example, create the execution environment, install an operating system within the execution environment, or manage a state of the environment in order to execute desired code in the environment. Similarly, the term “server-based environment” is intended to refer to an environment in which a user is at least partly responsible for managing generation, configuration, or state of an underlying execution environment in addition to executing desired code in the environment. One skilled in the art will thus appreciate that “serverless” and “server-based” may indicate the degree of user control over execution environments in which code is executed, rather than the actual absence or presence of a server.

In some embodiments, a user who submits a task to an on-demand code execution system may register the task with the on-demand code execution gateway or otherwise configure the gateway to invoke the on-demand code execution system. For example, the user may provide credentials that the on-demand code execution gateway may use to authenticate itself to the on-demand code execution system and submit a request to execute a task. As a further example, the user may specify one or more uniform resource locators (“URLs”) corresponding to requests that the gateway can fulfill by invoking on-demand code execution of a specified task. The on-demand code execution gateway may thus identify requests that can be fulfilled by invoking on-demand code execution of a user-submitted task.

As will be appreciated by one of skill in the art in light of the present disclosure, the embodiments disclosed herein improves the ability of computing systems, such as on-demand code execution systems, to execute code in an efficient manner. Moreover, the presently disclosed embodiments address technical problems inherent within computing systems; specifically, the problem of devices with limited computing resources being unable to utilize on-demand code execution systems due to computationally expensive requirements for providing input and output to these systems. These technical problems are addressed by the various technical solutions described herein, including the provisioning of an on-demand code execution gateway. Thus, the present disclosure represents an improvement on existing data processing systems and computing systems in general.

As described in more detail below, the on-demand code execution system may include a worker manager configured to receive user code (threads, programs, etc., composed in any of a variety of programming languages) and execute the code in a highly scalable, low latency manner, without requiring user configuration of a virtual machine instance. Specifically, the worker manager can, prior to receiving the user code and prior to receiving any information from a user regarding any particular virtual machine instance configuration, create and configure virtual machine instances according to a predetermined set of configurations, each corresponding to any one or more of a variety of run-time environments. Thereafter, the worker manager receives user-initiated requests to execute code, and identifies a pre-configured virtual machine instance to execute the code based on configuration information associated with the request. The worker manager can further allocate the identified virtual machine instance to execute the user's code at least partly by creating and configuring containers inside the allocated virtual machine instance, and provisioning the containers with code of the task as well as an dependency code objects. Various embodiments for implementing a worker manager and executing user code on virtual machine instances is described in more detail in U.S. Pat. No. 9,323,556, entitled “PROGRAMMATIC EVENT DETECTION AND MESSAGE GENERATION FOR REQUESTS TO EXECUTE PROGRAM CODE,” and filed Sep. 30, 2014 (the “'556 Patent”), the entirety of which is hereby incorporated by reference.

As used herein, the term “virtual machine instance” is intended to refer to an execution of software or other executable code that emulates hardware to provide an environment or platform on which software may execute (an “execution environment”). Virtual machine instances are generally executed by hardware devices, which may differ from the physical hardware emulated by the virtual machine instance. For example, a virtual machine may emulate a first type of processor and memory while being executed on a second type of processor and memory. Thus, virtual machines can be utilized to execute software intended for a first execution environment (e.g., a first operating system) on a physical device that is executing a second execution environment (e.g., a second operating system). In some instances, hardware emulated by a virtual machine instance may be the same or similar to hardware of an underlying device. For example, a device with a first type of processor may implement a plurality of virtual machine instances, each emulating an instance of that first type of processor. Thus, virtual machine instances can be used to divide a device into a number of logical sub-devices (each referred to as a “virtual machine instance”). While virtual machine instances can generally provide a level of abstraction away from the hardware of an underlying physical device, this abstraction is not required. For example, assume a device implements a plurality of virtual machine instances, each of which emulate hardware identical to that provided by the device. Under such a scenario, each virtual machine instance may allow a software application to execute code on the underlying hardware without translation, while maintaining a logical separation between software applications running on other virtual machine instances. This process, which is generally referred to as “native execution,” may be utilized to increase the speed or performance of virtual machine instances. Other techniques that allow direct utilization of underlying hardware, such as hardware pass-through techniques, may be used as well.

While a virtual machine executing an operating system is described herein as one example of an execution environment, other execution environments are also possible. For example, tasks or other processes may be executed within a software “container,” which provides a runtime environment without itself providing virtualization of hardware. Containers may be implemented within virtual machines to provide additional security, or may be run outside of a virtual machine instance.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

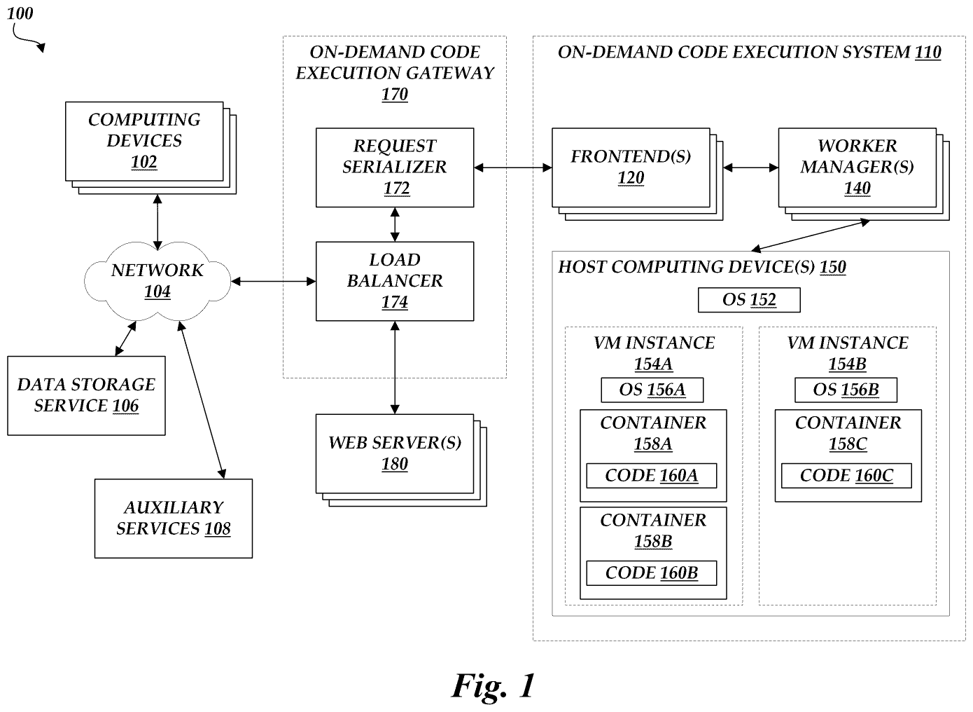

FIG. 1 is a block diagram of an illustrative operating environment 100 in which an on-demand code execution gateway 170 may operate based on communications with an on-demand code execution system 110, web servers 180, computing devices 102, auxiliary services 106, and network-based data storage services 108. In general, the computing devices 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. The on-demand code execution gateway 170 may provide the computing devices 102 with one or more user interfaces for invoking user-provided code (e.g., submitting a request to execute the user code on the on-demand code execution system 110). In some embodiments, the on-demand code execution gateway 170 may provide the computing devices 102 with an interface that allows the on-demand code execution gateway 170 to determine whether requests to execute code will be fulfilled by the on-demand code execution system 110 or one or more web servers 180. For example, the on-demand code execution gateway 170 may provide an interface that accepts input in a format understood by the web servers 180 (e.g., an HTTP “POST” method), and may determine whether to pass this input to the web servers 180 or translate it into a format understood by the on-demand code execution system 110.

The on-demand code execution gateway 170 includes a load balancer 174, which implements aspects of the present disclosure including, for example, providing an interface to the on-demand code execution system 110 that allows computing devices 102 to request execution of code on the system 110 without performing such actions as authenticating the request, generating the request into a format expected by the system 110, buffering and serializing the request, and other actions as described in more detail below. The on-demand code execution gateway 170 further includes a request serializer 172, which may serialize input and de-serialize output of the system 110 to facilitate communication between the system 110 and the computing devices 102. In some embodiments, the request serializer 172 may manage connections to the on-demand code execution system 110. For example, the request serializer 172 may maintain a connection to a frontend 120 to reduce the overhead costs associated with setting up and tearing down connections on a per-request basis.

In some embodiments, the load balancer 174 may interact with and distribute requests between a number of web servers 180. In further embodiments, as described in more detail below, the load balancer 174 may distribute requests to the on-demand code execution system 110 based on the workload of the web servers 180 or other criteria. The on-demand code execution gateway 170 may thus receive requests that can be fulfilled by the web servers 180, and the load balancer 174 may determine that the request should instead be fulfilled by the on-demand code execution system 110.

In some embodiments, the on-demand code execution system 110 may provide one or more user interfaces, command-line interfaces (CLIs), application programing interfaces (APIs), and/or other programmatic interfaces for generating and uploading user-executable code (e.g., including metadata identifying dependency code objects for the uploaded code), invoking the user-provided code (e.g., submitting a request directly to the on-demand code execution system 110, in a format understood by that system, to execute user-submitted code), scheduling event-based jobs or timed jobs, tracking the user-provided code, and/or viewing other logging or monitoring information related to their requests and/or user code. Although one or more embodiments may be described herein as using a user interface, it should be appreciated that such embodiments may, additionally or alternatively, use any CLIs, APIs, or other programmatic interfaces.

The illustrative environment 100 further includes one or more network-based data storage services 108, configured to enable the on-demand code execution system 110 to store and retrieve data from one or more persistent or substantially persistent data sources. Illustratively, the network-based data storage services 108 may enable the on-demand code execution system 110 to store information corresponding to a task, such as code or metadata, to store additional code objects representing dependencies of tasks, to retrieve data to be processed during execution of a task, and to store information (e.g., results) regarding that execution. The network-based data storage services 108 may represent, for example, a relational or non-relational database. In another example, the network-based data storage services 108 may represent a network-attached storage (NAS), configured to provide access to data arranged as a file system. The network-based data storage services 108 may further enable the on-demand code execution system 110 to query for and retrieve information regarding data stored within the on-demand code execution system 110, such as by querying for a number of relevant files or records, sizes of those files or records, file or record names, file or record creation times, etc. In some instances, the network-based data storage services 108 may provide additional functionality, such as the ability to separate data into logical groups (e.g., groups associated with individual accounts, etc.). While shown as distinct from the auxiliary services 106, the network-based data storage services 108 may in some instances also represent a type of auxiliary service 106.

The computing devices 102, auxiliary services 106, and network-based data storage services 108 may communicate with the on-demand code execution gateway 170 via a network 104, which may include any wired network, wireless network, or combination thereof. For example, the network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein. In some embodiments, the on-demand code execution gateway 170 may communicate with the web servers 180 or the on-demand code execution system 110 via the network 104 or another network.

The on-demand code execution system 110, on-demand code execution gateway 170, and web servers 180 are depicted in FIG. 1 as operating in a distributed computing environment including several computer systems that are interconnected using one or more computer networks (not shown in FIG. 1). The system 110, gateway 170, and servers 180 could also operate within a computing environment having more or fewer devices than are illustrated in FIG. 1. Additionally, while shown as separate systems, the system 110, gateway 170, and servers 180 (or any combination thereof) may in some embodiments be implemented as a single system. Thus, the depictions of the system 110, gateway 170, and servers 180 in FIG. 1 should be taken as illustrative and not limiting to the present disclosure. For example, the on-demand code execution system 110, the gateway 170, and/or the servers 180 (or various constituents thereof) could implement various Web services components, hosted or “cloud” computing environments, and/or peer to peer network configurations to implement at least a portion of the processes described herein.

Further, the on-demand code execution system 110, the on-demand code execution gateway 170, and the web servers 180 may be implemented directly in hardware or software executed by hardware devices and may, for instance, include one or more physical or virtual servers implemented on physical computer hardware configured to execute computer executable instructions for performing various features that will be described herein. The one or more servers may be geographically dispersed or geographically co-located, for instance, in one or more data centers. In some instances, the one or more servers may operate as part of a system of rapidly provisioned and released computing resources, often referred to as a “cloud computing environment.”

In some embodiments, any of the components within the on-demand code execution system 110 can communicate with other components of the on-demand code execution system 110 via the network 104. In other embodiments, not all components of the on-demand code execution system 110 are capable of communicating with other components of the environment 100. In one example, only the frontend 120 (which may in some instances represent multiple frontends 120) may be connected to the gateway 170 or the network 104, and other components of the on-demand code execution system 110 may communicate with other components of the environment 100 via the frontends 120.

The on-demand code execution system 110 includes one or more frontends 120, which enable interaction with the on-demand code execution system 110. In an illustrative embodiment, the frontends 120 serve as an interface allowing the on-demand code execution gateway 170 to request execution of user-submitted code. In some embodiments, the frontends 120 also serve as a “front door” to other services provided by the on-demand code execution system 110, enabling users to, for example provide computer executable code. The frontends 120 include a variety of components to enable interaction between the on-demand code execution system 110 and other computing devices. For example, each frontend 120 may include a request interface providing computing devices 102 with the ability to upload or otherwise communicate user-specified code to the on-demand code execution system 110, and may enable computing devices 102 that are capable of doing so to request execution of that code without going through the gateway 170. In one embodiment, the request interface communicates with external computing devices (e.g., computing devices 102, auxiliary services 106, etc.) via a graphical user interface (GUI), CLI, or API. The frontends 120 process the requests and makes sure that the requests are properly authorized. For example, the frontends 120 may determine whether the user associated with the request is authorized to access the user code specified in the request. In the illustrated embodiment of FIG. 1, the frontends 120 may determine whether the on-demand code execution gateway 170 has been authorized to access the user code specified in a request.

References to user code as used herein may refer to any program code (e.g., a program, routine, subroutine, thread, etc.) written in a specific program language. In the present disclosure, the terms “code,” “user code,” and “program code,” may be used interchangeably. Such user code may be executed to achieve a specific function, for example, in connection with a particular web application or mobile application developed by the user. As noted above, individual collections of user code (e.g., to achieve a specific function) are referred to herein as “tasks,” while specific executions of that code (including, e.g., compiling code, interpreting code, or otherwise making the code executable) are referred to as “task executions” or simply “executions.” Tasks may be written, by way of non-limiting example, in JavaScript (e.g., node.js), Java, Python, and/or Ruby (and/or another programming language). Tasks may be “triggered” for execution on the on-demand code execution system 110 in a variety of manners. In one embodiment, a user or other computing device may transmit a request to execute a task may, which can generally be referred to as “call” to execute of the task. Such calls may include the user code (or the location thereof) to be executed and one or more arguments to be used for executing the user code. For example, a call may provide the user code of a task along with the request to execute the task. In another example, a call may identify a previously uploaded task by its name or an identifier. In yet another example, code corresponding to a task may be included in a call for the task, as well as being uploaded in a separate location (e.g., storage of an auxiliary service 106 or a storage system internal to the on-demand code execution system 110) prior to the request being received by the on-demand code execution system 110. As noted above, the code for a task may reference additional code objects maintained at the on-demand code execution system 110 by use of identifiers of those code objects, such that the code objects are combined with the code of a task in an execution environment prior to execution of the task. The on-demand code execution system 110 may vary its execution strategy for a task based on where the code of the task is available at the time a call for the task is processed. A request interface of the frontend 120 may receive calls to execute tasks as Hypertext Transfer Protocol Secure (HTTPS) requests from a user. Also, any information (e.g., headers and parameters) included in the HTTPS request may also be processed and utilized when executing a task. As discussed above, any other protocols, including, for example, HTTP, MQTT, and CoAP, may be used to transfer the message containing a task call to the request interface.

To manage requests for code execution, the frontend 120 can include an execution queue (not shown in FIG. 1), which can maintain a record of requested task executions. Illustratively, the number of simultaneous task executions by the on-demand code execution system 110 is limited, and as such, new task executions initiated at the on-demand code execution system 110 (e.g., via an API call, via a call from an executed or executing task, etc.) may be placed on the execution queue and processed, e.g., in a first-in-first-out order. In some embodiments, the on-demand code execution system 110 may include multiple execution queues, such as individual execution queues for each user account. For example, users of the on-demand code execution system 110 may desire to limit the rate of task executions on the on-demand code execution system 110 (e.g., for cost reasons). Thus, the on-demand code execution system 110 may utilize an account-specific execution queue to throttle the rate of simultaneous task executions by a specific user account. In some instances, the on-demand code execution system 110 may prioritize task executions, such that task executions of specific accounts or of specified priorities bypass or are prioritized within the execution queue. In other instances, the on-demand code execution system 110 may execute tasks immediately or substantially immediately after receiving a call for that task, and thus, the execution queue may be omitted.

The frontend 120 can further include an output interface (not shown in FIG. 1) configured to output information regarding the execution of tasks on the on-demand code execution system 110. Illustratively, the output interface may transmit data regarding task executions (e.g., results of a task, errors related to the task execution, or details of the task execution, such as total time required to complete the execution, total data processed via the execution, etc.) to the on-demand code execution gateway 170, computing devices 102, or to auxiliary services 106, which may include, for example, billing or logging services. The output interface may further enable transmission of data, such as service calls, to auxiliary services 106. For example, the output interface may be utilized during execution of a task to transmit an API request to an external service 106 (e.g., to store data generated during execution of the task).

To execute tasks, the on-demand code execution system 110 includes one or more worker managers 140 that manage the instances used for servicing incoming calls to execute tasks. In the example illustrated in FIG. 1, each worker manager 140 manages an active pool of virtual machine instances 154A-B, which are currently assigned to one or more users and are implemented by one or more physical host computing devices 150. The physical host computing devices 150 and the virtual machine instances 154A-B may further implement one or more containers 158A-C, which may contain and execute one or more user-submitted codes 160A-G. Containers are logical units created within a virtual machine instance, or on a host computing device, using the resources available on that instance or device. For example, each worker manager 140 may, based on information specified in a call to execute a task, create a new container or locate an existing container 158A-C and assign the container to handle the execution of the task.

The containers 156A-C, virtual machine instances 154A-B, and host computing devices 150 may further include language runtimes, code libraries, or other supporting functions (not depicted in FIG. 1) that facilitate execution of user-submitted code 160A-C. The physical computing devices 150 and the virtual machine instances 154A-B may further include operating systems 152 and 156A-B. In various embodiments, operating systems 152 and 156A-B may be the same operating system, variants of the same operating system, different operating systems, or combinations thereof.

Although the virtual machine instances 154A-B are described here as being assigned to a particular user, in some embodiments, an instance 154A-B may be assigned to a group of users, such that the instance is tied to the group of users and any member of the group can utilize resources on the instance. For example, the users in the same group may belong to the same security group (e.g., based on their security credentials) such that executing one member's task in a container on a particular instance after another member's task has been executed in another container on the same instance does not pose security risks. Similarly, the worker managers 140 may assign the instances and the containers according to one or more policies that dictate which requests can be executed in which containers and which instances can be assigned to which users. An example policy may specify that instances are assigned to collections of users who share the same account (e.g., account for accessing the services provided by the on-demand code execution system 110). In some embodiments, the requests associated with the same user group may share the same containers (e.g., if the user codes associated therewith are identical). In some embodiments, a task does not differentiate between the different users of the group and simply indicates the group to which the users associated with the task belong.

Once a triggering event to execute a task has been successfully processed by a frontend 120, the frontend 120 passes a request to a worker manager 140 to execute the task. In one embodiment, each frontend 120 may be associated with a corresponding worker manager 140 (e.g., a worker manager 140 co-located or geographically nearby to the frontend 120) and thus the frontend 120 may pass most or all requests to that worker manager 140. In another embodiment, a frontend 120 may include a location selector configured to determine a worker manager 140 to which to pass the execution request. In one embodiment, the location selector may determine the worker manager 140 to receive a call based on hashing the call, and distributing the call to a worker manager 140 selected based on the hashed value (e.g., via a hash ring). Various other mechanisms for distributing calls between worker managers 140 will be apparent to one of skill in the art. In accordance with embodiments of the present disclosure, the worker manager 140 can determine a host computing device 150 or a virtual machine instance 154A-B for executing a task.

As shown in FIG. 1, various combinations and configurations of host computing devices 150, virtual machine instances 154A-B, and containers 158A-C may be used to facilitate execution of user submitted code 160A-C. In the illustrated example, the host computing device 150 implements two virtual machine instances 154A and 154B. Virtual machine instance 154A, in turn, implements two containers 158A and 158B, which contain user-submitted code 160A and 160B respectively. Virtual machine instance 154B implements a single container 158C, which contains user-submitted code 160C. It will be understood that these embodiments are illustrated for purposes of example, and that many other embodiments are within the scope of the present disclosure.

While some functionalities are generally described herein with reference to an individual component of the on-demand code execution system 110, other components or a combination of components may additionally or alternatively implement such functionalities. For example, a worker manager 140 may operate to provide functionality associated with execution of user-submitted code as described herein with reference to an on-demand code execution gateway 170.

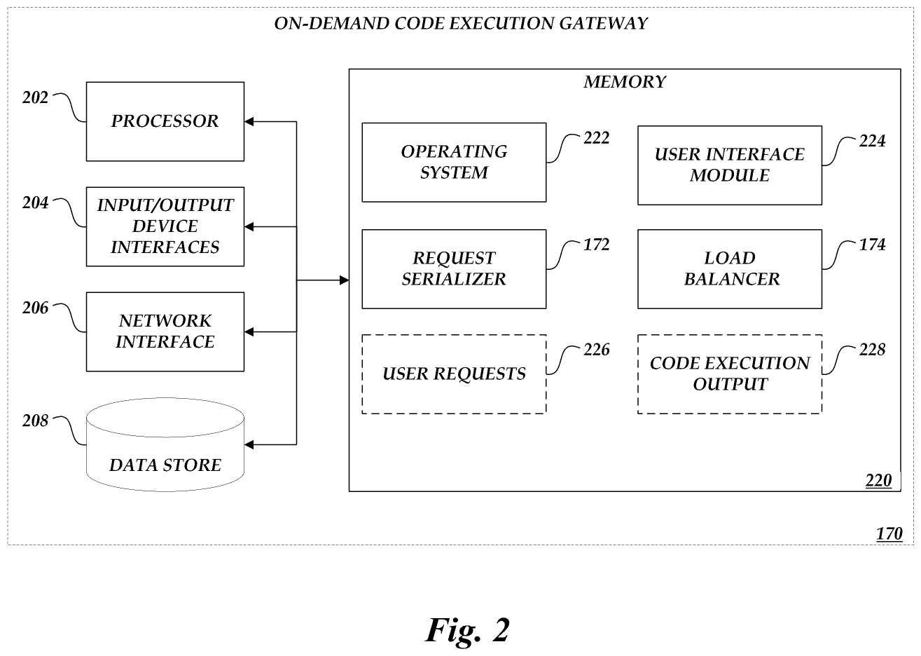

FIG. 2 depicts a general architecture of a computing system (referenced as on-demand code execution gateway 170) that operates to provide an interface to the on-demand code execution system 110. The general architecture of the on-demand code execution gateway 170 depicted in FIG. 2 includes an arrangement of computer hardware and software modules that may be used to implement aspects of the present disclosure. The hardware modules may be implemented with physical electronic devices, as discussed in greater detail below. The on-demand code execution gateway 170 may include many more (or fewer) elements than those shown in FIG. 2. It is not necessary, however, that all of these generally conventional elements be shown in order to provide an enabling disclosure. Additionally, the general architecture illustrated in FIG. 2 may be used to implement one or more of the other components illustrated in FIG. 1. As illustrated, the on-demand code execution gateway 170 includes a processor 202, input/output device interfaces 204, a network interface 206, and a data store 208, all of which may communicate with one another by way of a communication bus. The network interface 206 may provide connectivity to one or more networks or computing systems. The processor 202 may thus receive information and instructions from other computing systems or services via the network 104. The processor 202 may also communicate to and from a memory 220 and further provide output information for an optional display (not shown) via the input/output device interfaces 204. The input/output device interfaces 204 may also accept input from an optional input device (not shown).

The memory 220 may contain computer program instructions (grouped as modules in some embodiments) that the processor 202 executes in order to implement one or more aspects of the present disclosure. The memory 220 generally includes random access memory (RAM), read only memory (ROM) and/or other persistent, auxiliary or non-transitory computer readable media. The memory 220 may store an operating system 222 that provides computer program instructions for use by the processor 202 in the general administration and operation of the on-demand code execution gateway 170. The memory 220 may further include computer program instructions and other information for implementing aspects of the present disclosure. For example, in one embodiment, the memory 220 includes a user interface module 224 that generates interfaces (and/or instructions therefor) that enable access to the on-demand code execution server 110. In addition, the memory 220 may include and/or communicate with one or more data repositories (not shown), for example, to access user program codes and/or libraries.

In addition to and/or in combination with the user interface module 224, the memory 220 may include a request serializer 172 and a load balancer 174 that may be executed by the processor 202. In one embodiment, the request serializer 172 and load balancer 174 individually or collectively implement various aspects of the present disclosure, e.g., processing request for network resources and serializing them into a format understood by an on-demand code execution server 110, as described further below.

While the request serializer 172 and load balancer 174 are shown in FIG. 2 as part of the on-demand code execution gateway 170, in other embodiments, all or a portion of the request serializer 172 and load balancer 174 may be implemented by other components of the on-demand code execution system 110 and/or another computing device. For example, in certain embodiments of the present disclosure, another computing device in communication with the on-demand code execution system 110 may include several modules or components that operate similarly to the modules and components illustrated as part of the on-demand code execution gateway 170.

The memory 220 may further include user requests 226, which may be loaded into memory in conjunction with a user-submitted request that can be fulfilled by executing a task on the on-demand code execution system 110. The memory 220 may further include execution output 228, which may be received from the on-demand code execution system 110 after a task has been executed.

In some embodiments, the on-demand code execution gateway 170 may further include components other than those illustrated in FIG. 2. For example, the memory 220 may further include information regarding various user-submitted codes that are available for execution, authentication information for accessing various user-submitted codes, or metadata or other information that was submitted with the request. FIG. 2 is thus understood to be illustrative but not limiting.

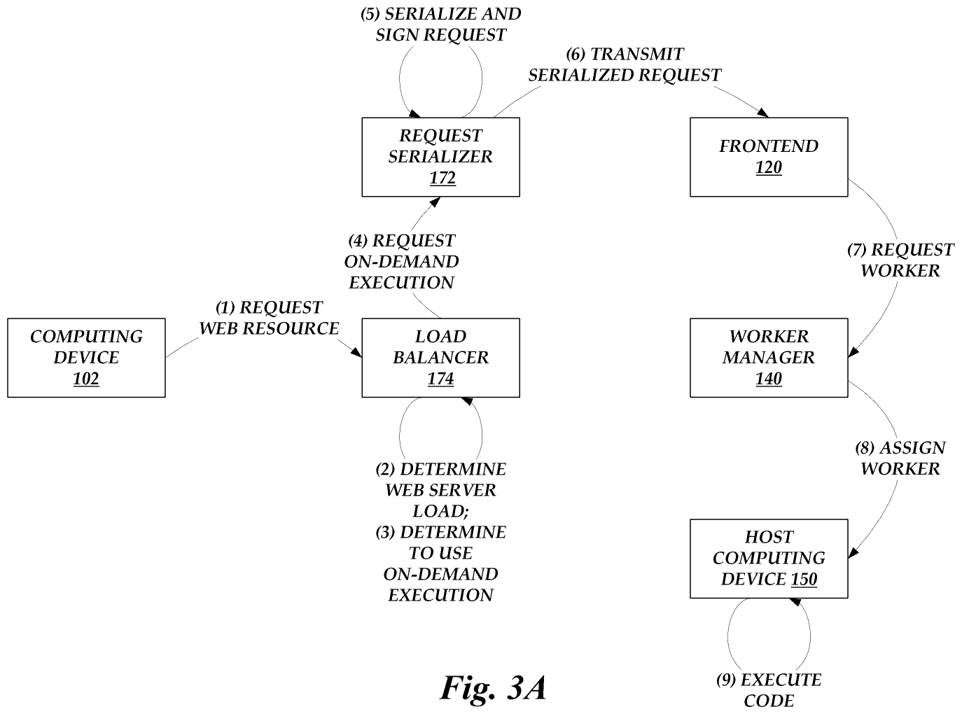

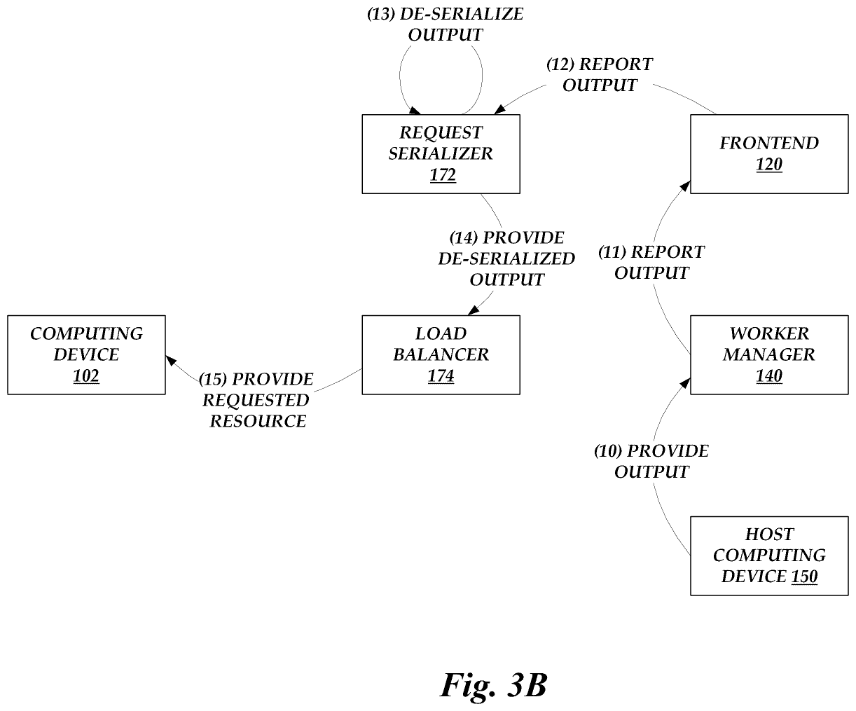

FIGS. 3A and 3B depict illustrative interactions for fulfilling requests for computing resources, such as requests to access a web page or a web-based application, via an on-line code execution gateway. With reference now to FIG. 3A, at (1), a computing device 102 requests a network resource. Illustratively, the request may be in the form of a Uniform Resource Locator (“URL”), which may be transmitted by the computing device to the load balancer 174. At (2), in some embodiments, the load balancer 174 assesses the current workloads of the servers it balances (which are not depicted in FIG. 3A) to determine whether any of these servers have capacity to fulfill the request. In some embodiments, the load balancer 174 may obtain server load information from the servers in the form of processor utilization metrics, memory usage, and other such measurements. In other embodiments, the load balancer 174 may determine server load based on the volume and frequency of requests that it has assigned.

In some embodiments, the load balancer 174 determines that one of its servers has sufficient capacity to fulfill the request, and assigns the request to the server. In other embodiments, at (3), the load balancer 174 determines that none of its servers currently have sufficient capacity to fulfill the request, and thus determines to fulfill the request using on-demand execution. In some embodiments, the load balancer 174 may determine to use on-demand execution for reasons other than server load. For example, the load balancer 174 may determine that on-demand code execution will make better use of computing resources, will provide better performance (e.g., faster results), provide lower latency for certain requests, or apply other criteria to make the determination to use on-demand execution. Having made such a determination, at (4), the load balancer 174 then passes the request to the request serializer 172.

In some embodiments, the load balancer 174 may act as a firewall that prevents malformed or malicious requests from reaching an on-demand code execution system and/or other servers. For example, the load balancer 174 may authenticate a request it receives by, e.g., exchanging tokens or otherwise verifying the source of the request. In further embodiments, the load balancer 174 may throttle requests to the on-demand code execution system or otherwise protect the integrity of the on-demand code execution system.

In some embodiments, the load balancer 174 may determine that the numbers of servers in its server pool should be increased based on the number of requests that the servers are unable to fulfill due to load, or may determine the number of servers may be decreased if few or no requests are being fulfilled via on-demand code execution. The load balancer 174 may analyze the quantity and timing of the requests it receives, and may assess the cost-benefit tradeoff of instantiating additional servers. For example, the load balancer 174 may determine that it is experiencing a temporary “spike” or increase in traffic, and that the spike will be over before it can bring additional servers online. As a further example, the load balancer 174 may determine that few or no requests are being fulfilled via on-demand code execution, and server workloads are such that the number of servers can be reduced. In some embodiments, the number of servers may be reduced to zero (e.g., a determination may be made that all requests should be fulfilled via on-demand code execution). In some embodiments, the load balancer 174 or another component of the on-demand code execution gateway 170 may perform a cost-benefit analysis of adding or removing a server, and may consider factors such as request response times, idle capacity, costs associated with on-demand code execution, costs associated with maintaining a server, and other factors.

At (4), the load balancer 174 may pass the request for a network resource to the request serializer 172, which may encode the request into a format accepted by an on-demand code execution system. Illustratively, the on-demand code execution system may require that requests be in a particular format. For example, the system may require that a request include certain headers or other metadata in a particular format, or that the body of the request be formatted as a base64-encoded JavaScript Object Notation (“JSON”) string or blog.

At (5), the request serializer 172 serializes the request. Illustratively, the request may be serialized by converting it to a format that is accepted by an on-demand code execution system, or by generating a “blank” request in an accepted format and populating it with information from the originally received request. In some embodiments, the request serializer 172 may generate a hash key, signature, token, or other identifier to allow the on-demand code execution system to authenticate the request. The request serializer 172 may also provide other information that is absent from the originally received request but required by the on-demand code execution system, such as information identifying the particular task or user-submitted code that may be executed to fulfill the request. In some embodiments, the request serializer 172 or the load balancer 174 may determine the appropriate task to execute based on characteristics of the request, such as an originating IP address, destination IP address, information contained in a URL string or in HTTP headers, or other characteristics.

In some embodiments, as described above, the request for a network resource may not be received all at once. For example, the request may be to process an image, data file, or other binary object, and the body of the request may include the object and may be distributed across multiple packets or messages. The request serializer 172 may thus buffer portions of the request until a complete request has been received, so that the entire request can be signed and provided to the on-demand code execution system.

At (6), the serialized request, which may also be referred to herein as an “encoded input,” is transmitted to a frontend 120 of an on-demand code execution system. The frontend 120 processes the serialized request, identifies a suitable worker manager 140, and at (7) requests that the worker manager 140 assign a worker to execute the requested code. At (8), the worker manager 140 identifies a host computing device 150 that can instantiate a “worker” execution environment (e.g., a virtual machine instance or a container within a virtual machine instance) to execute the task, and assigns the task to the execution environment on the host computing device 150. In some embodiments, the worker manager 140 may identify an existing execution environment to execute the task and assign the task accordingly. At (9), the execution environment on the host computing device 150 executes the task.

In some embodiments, the load balancer 174 or the request serializer 172 may interact with multiple frontends 120 or multiple code on-demand code execution systems, and may assign requests to different frontends, different on-demand code execution systems, or different tasks within an on-demand code execution system. For example, the load balancer 174 may assign requests to be fulfilled by a high-performance task that consumes more computing resources when load on the on-demand code execution system is low, and may assign requests to be fulfilled by a task that consumes fewer resources but still produces acceptable results when load is high. The load balancer 174 or the request serializer 172 may, in some embodiments, perform a periodic or demand-driven health check on the frontends 120, on-demand code execution systems, or executing tasks, and may fail over to a different frontend 120, on-demand code execution system, or task if the health check indicates a problem with task execution.

With reference now to FIG. 3B, at (10), the host computing device 150 provides the output of executing the task to the worker manager 140, who at (11) reports the output to the frontend 120. At (12), the frontend 120 provides the output to the request serializer 172. In some embodiments, the host computing device 150 or the worker manager 140 may communicate directly with the request serializer 172, and some or all of the interactions at (10), (11), and (12) may be combined. In some embodiments, the output may be encoded or serialized. For example, the output may be in a format that corresponds to the encoded input, such as a response to an API call, or may have headers or metadata that correspond to headers or metadata in the encoded input.

At (13), the request serializer 172 de-serializes the output. Illustratively, de-serializing the output may convert the output to a format expected by the computing device 102, such as an HTTP response that corresponds to the original request. In some embodiments, the request serializer 172 may remove or convert metadata associated with the output. For example, the request serializer 172 may move metadata into optional HTTP headers, or may make the output similar or identical to the output that a server-based application would have generated. In some embodiments, the output may include status messages or error messages that are specific to the on-demand code execution system, which may be translated or converted into status or error messages in another format (e.g., into the equivalent message that would have been generated by a server-based application), or may be retained in the converted output as indications that the request was fulfilled by an on-demand code execution system. At (14), the request serializer provides the decoded or de-serialized output to the load balancer 174, when at (15) provides the output to the requesting computing device 102 as a response to the original request.

In some embodiments, the ordering and implementation of operations described above may be modified, or these interactions may be carried out by additional or alternative elements of the on-demand code execution gateway 170. For example, in some embodiments, the interactions at (2) and (3) may be omitted and the load balancer 174 may fulfill all requests by utilizing the on-demand code execution system. As a further example, in some embodiments, the request serializer 172 may bypass the frontend 120 and communicate directly with the worker manager 140. The interactions depicted in FIGS. 3A-3B are thus understood to be illustrative and not limiting.

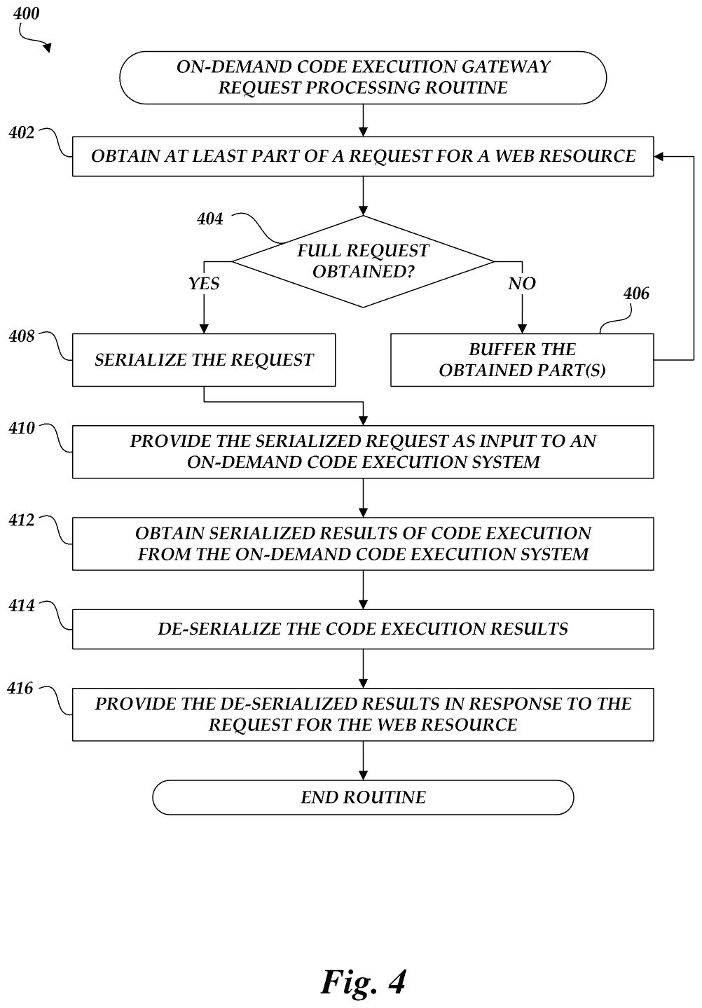

FIG. 4 is a flow diagram of an illustrative routine 400 for processing requests for computing resources by using an on-demand code execution gateway. The routine 400 may be carried out, for example, by the on-demand code execution gateway 170 depicted in FIG. 1 or various components thereof. At block 402, at least part of a request for a network resource may be obtained. Illustratively, the request may be to access web content, interact with an application, read or write to a storage volume, or access other resources. In various embodiments, as described above, the request may be received in its entirety or received in stages or portions.

At decision block 404, a determination may be made as to whether a complete request has been obtained. If not, then the routine 400 branches to block 406, where the portions of the request that have been obtained thus far are stored in a memory buffer until the rest of the request is received. The routine 400 then returns to block 402 and awaits further portions of the request. In some embodiments, the routine 400 may process multiple requests in parallel, and may determine which request is associated with the portion received at block 402 and whether the portion completes that request. Additionally, in some embodiments, the size of a complete request may exceed the size of the memory buffer for storing requests. If so, then in various embodiments the routine 400 may reject the request, truncate the request, assign the request to a web server (e.g., the web server(s) 180 as depicted in FIG. 1), stream all or part of the request to an on-demand code execution system, divide the request into smaller requests, or otherwise process the request.

If the determination at decision block 404 is that a complete request has been obtained, then the routine 400 branches to block 408, where the complete request may be serialized. As described above, all or part of the request may be serialized by converting or encoding the request into a format accepted by the on-demand code execution system. The request may, for example, be converted into a JSON object or objects, an HTTP method, an API call, or otherwise encoded into another format or notation.

At block 410, the serialized request may be provided as encoded input to an on-demand code execution system, and at block 412 the resulting encoded output may be obtained in a serialized format. Illustratively, as described above, the routine 400 may include authentication information as part of the request, or in some embodiments may authenticate separately from submitting a request to execute the task. For example, the routine 400 may provide credentials that confirm the user who submitted the code has authorized access via an on-demand code execution gateway. In other embodiments, the routine 400 may authenticate the request itself by signing the request or including a hash key as part of the request.

At block 414, the output from executing the task may be de-serialized and converted into a format understood by the requesting computing device. For example, the output may be converted from a JSON object or objects into an HTTP response, or all or part of the output may be converted from base64 notation into a binary notation. In some embodiments, the output may be made similar or identical to output that a server would provide if executing the task or an analogous task. In other embodiments, information indicating that the request was fulfilled by an on-demand code execution may be included in the output. At block 416, the de-serialized output may be provided in response to the original request.

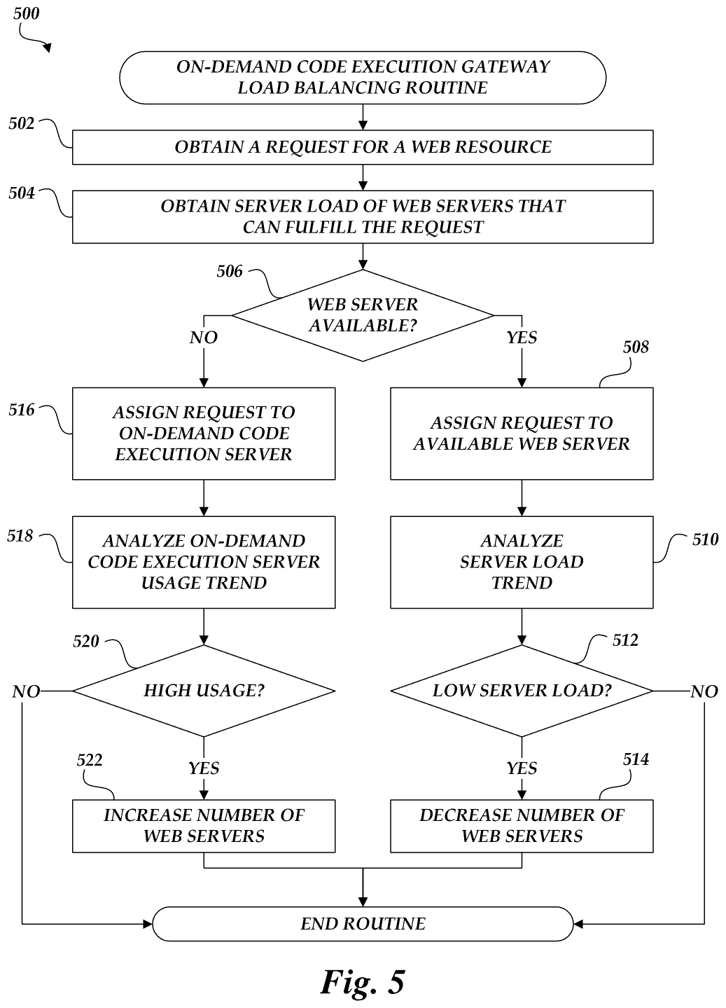

FIG. 5 if a flow diagram of an illustrative routine 500 for utilizing an on-demand code execution system to provide load balancing. Offloading requests to an on-demand code execution system may allow more efficient management of computing resources. For example, on-demand code execution may be utilized to address portions of a workload that exceed the capacity of a pool of servers, but that are not sufficient to justify increasing the size of the pool. As further examples, on-demand code execution may be utilized to allow underused servers to be removed from the pool, or to handle a sudden increase in requests when servers cannot be added to the pool quickly enough.

At block 502, a request for a computing resource may be obtained as described above. At block 504, information regarding the current load of servers that can fulfill the request may be obtained. In some embodiments, as described above, server load information may be obtained from the servers themselves as metrics representing resource utilization or consumption. In other embodiments, server load may be determined or estimated based on the number and rate at which previous iterations of the routine 500 have assigned requests to the servers.

At decision block 506, a determination may be made as to whether a server is available to fulfill the request. In some embodiments, the incremental workload that the request represent may be determined, and the determination may be as to whether a server can accept the incremental workload and still meet performance targets (e.g., response times or resource utilization targets). In other embodiments, the capacity of each server may be determined or predetermined as a number of requests that can be processed in parallel, and this threshold may be compared to the number of requests that a server is currently processing. If the determination is that a server is available, then at block 508 the request is assigned to the server. At block 510, server load information may be compared to historical server load information, and an assessment may be made as to whether the servers are underutilized or whether it would be more efficient to fulfill more requests using on-demand code execution.

At decision block 512, a determination may be made as to whether server workloads and utilization of on-demand code execution are such that the number of servers should be reduced. If so, then at block 514 one or more servers may be released. Illustratively, a server may be released by deactivating a virtual machine instance, de-allocating physical hardware that has been allocated to a resource pool, or otherwise removing computing resources from the server pool. If the determination is that the number of servers should not be reduced, then the routine 500 ends without taking further action. In some embodiments, the routine 500 is executed continuously and instead branches to block 502 to await further requests for resources.

If the determination at decision block 506 is that no web server has sufficient available capacity to fulfill the request, then the routine 500 branches to block 516. In some embodiments, the determination at decision block 506 may be based on criteria other than the available capacity of the servers. For example, a determination may be made that on-demand code execution is likely to provide a faster response given the current server workloads, or that the characteristics of a particular request make on-demand code execution preferable. For example, on-demand code execution may be faster (or may provide acceptable performance) for certain types of requests, while other types of requests may require server resources. In further embodiments, the code that is executed by the on-demand code execution service may differ from the code executed by the servers, and may provide different results under certain conditions. The determination at decision block 506 may therefore be as to whether the conditions are met.

At block 516, the request may be assigned to an on-demand code execution server and fulfilled by executing user-submitted code, as described above. At block 518, usage of the on-demand code execution server may be analyzed relative to historical usage of on-demand code execution or usage of the servers. In some embodiments, the server load information obtained at block 504 may be analyzed.

At decision block 520, a determination may be made as to whether the usage of the on-demand code execution server is such that the size of the server pool should be increased. Illustratively, the determination may be that the usage exceeds a threshold for a specified time interval, or that the usage trend is increasing at a threshold rate. If the determination is that adding a server or server(s) to the pool is justified, then at block 522 one or more servers are added. If not, then the routine 500 ends (or in some embodiments returns to block 502 and awaits further input).

The blocks of the routines described above may vary in embodiments of the present disclosure. For example, in some embodiments of the routine 400, block 414 may be omitted and the output of the on-demand code execution may be provided in a serialized format. As a further example, blocks 510-514 and 516-522 of the routine 500 may be carried out independently of obtaining a request for a computing resource. For example, these blocks may be carried out periodically or in response to detecting that server loads are above or below a threshold. The routines may further include additional blocks, or the blocks of the routines may be rearranged or combined, according to various embodiments. In further embodiments, all or part of the routines may be combined.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

1. (canceled)

2. A computer-implemented method comprising:
determining, based at least in part on a predicted time of a set of servers configured to fulfill requests for network resources and independent of a capacity of a serverless computing system, whether to fulfill a request for a network resource by executing a task on the serverless computing system or by assigning the request to a server of the set of servers;
in response to determining to fulfill the request for the network resource by executing the task on the serverless computing system, causing the serverless computing system to execute the task and transmit a version of output generated by the serverless computing system executing the task, wherein the version of the output fulfills the request for the network resource;
determining, based at least in part on an additional request and a plurality of previous requests for the network resource that were fulfilled by an on-demand code execution system, to increase a number of servers in the set of servers; and
causing at least one additional server to be added to the set of servers.

3. The computer-implemented method of claim 2, wherein causing the serverless computing system to execute the task and transmit the version of the output generated by the serverless computing system executing the task comprises:
generating an encoded input based at least in part on the additional request; and
transmitting the encoded input to the serverless computing system.

4. The computer-implemented method of claim 3, wherein the encoded input includes information identifying the task.

5. The computer-implemented method of claim 2, further comprising generating a demand forecast for the network resource.

6. The computer-implemented method of claim 5, further comprising determining, based at least in part on a length of time required to add a server to the set of servers, to fulfill at least a portion of the demand forecast by using the serverless computing system.

7. The computer-implemented method of claim 5, further comprising determining, based at least in part on the demand forecast, to remove a server from the set of servers.

8. The computer-implemented method of claim 2, further comprising identifying the task based at least in part on the request.

9. A system comprising:
a non-transitory data store storing information regarding tasks that are executable on a serverless computing system; and
a computing device configured with executable instructions to:
determine, based at least in part on a predicted time of a set of servers configured to fulfill requests for network resources and independent of a capacity of a serverless computing system, whether to fulfill a request for a network resource by executing a task on the serverless computing system or by assigning the request to a server of the set of servers;
in response to a determination to fulfill the request for the network resource by executing the task on the serverless computing system, cause the serverless computing system to execute the task and transmit a version of output generated by the serverless computing system executing the task, wherein the version of the output fulfills the request for the network resource;
determine, based at least in part on an additional request and a plurality of previous requests for the network resource that were fulfilled by an on-demand code execution system, to increase a number of servers in the set of servers; and
cause at least one additional server to be added to the set of servers.

10. The system of claim 9, wherein the computing device is further configured to:
generate an encoded input based at least in part on the additional request; and
transmit the encoded input to the serverless computing system.

11. The system of claim 10, wherein the encoded input includes information identifying the task.

12. The system of claim 9, wherein the computing device is further configured to generate a demand forecast for the network resource.

13. The system of claim 12, wherein the computing device is further configured to determine, based at least in part on a length of time required to add a server to the set of servers, to fulfill at least a portion of the demand forecast by using the serverless computing system.

14. The system of claim 12, wherein the computing device is further configured to determine, based at least in part on the demand forecast, to remove a server from the set of servers.

15. The system of claim 9, wherein the computing device is further configured to identify the task based at least in part on the request.

16. One or more non-transitory computer-readable media including computer-executable instructions that, when executed by a computing system, cause the computing system to:
determine, based at least in part on a predicted time of a set of servers configured to fulfill requests for network resources and independent of a capacity of a serverless computing system, whether to fulfill a request for a network resource by executing a task on the serverless computing system or by assigning the request to a server of the set of servers;
in response to a determination to fulfill the request for the network resource by executing the task on the serverless computing system, cause the serverless computing system to execute the task and transmit a version of output generated by the serverless computing system executing the task, wherein the version of the output fulfills the request for the network resource;
determine, based at least in part on an additional request and a plurality of previous requests for the network resource that were fulfilled by an on-demand code execution system, to increase a number of servers in the set of servers; and
cause at least one additional server to be added to the set of servers.

17. The one or more non-transitory computer-readable media of claim 16, including further computer-executable instructions that cause the computing system to:
generate an encoded input based at least in part on the additional request; and
transmit the encoded input to the serverless computing system.

18. The one or more non-transitory computer-readable media of claim 17, wherein the encoded input includes information identifying the task.

19. The one or more non-transitory computer-readable media of claim 16, including further computer-executable instructions that cause the computing system to generate a demand forecast for the network resource.

20. The one or more non-transitory computer-readable media of claim 19, including further computer-executable instructions that cause the computing system to determine, based at least in part on a length of time required to add a server to the set of servers, to fulfill at least a portion of the demand forecast by using the serverless computing system.

21. The one or more non-transitory computer-readable media of claim 19, including further computer-executable instructions that cause the computing system to determine, based at least in part on the demand forecast, to remove a server from the set of servers.
